(19) United States
(12) Patent Application Publication
(10) Pub. No.: US 2014/0376555 A1
(43) Pub. Date: Dec. 25, 2014

(54) NETWORK FUNCTION VIRTUALIZATION METHOD AND APPARATUS USING THE SAME

(71) Applicant: ELECTRONICS AND TELECOMMUNICATIONS RESEARCH INSTITUTE, Daejeon (KR)

(72) Inventors: Kang Il CHOI, Daejeon (KR); Bhum Cheol LEE, Daejeon (KR); Jung Hee LEE, Daejeon (KR); Sang-Min LEE, Daejeon (KR); Seung-Woo LEE, Daejeon (KR); Young Ho PARK, Daejeon (KR)

(21) Appl. No.: 14/311,281

(22) Filed: Jun. 21, 2014

(30) Foreign Application Priority Data
Jun. 24, 2013 (KR) 10-2013-0072543
Jun. 19, 2014 (KR) 10-2014-0075118

(51) Int. Cl. H04L 12/721; H04L 12/931

(52) U.S. Cl. CPC H04L 45/66; H04L 49/70
USPC 370/395.53

(57) ABSTRACT

A network function virtualization device includes at least one network function virtual machine; and a network function flow switch configured to receive flows and to switch the flows to the at least one network function virtual machine, and a network functions virtualization method for applying the virtualized network function to the flows.

### CROSS-REFERENCE TO RELATED APPLICATION

This application claims priority to and the benefit of Korean Patent Application Nos. 10-2013-0072543 and 10-2014-0075118 filed in the Korean Intellectual Property Office on Jun. 24, 2013 and Jun. 19, 2014, the entire contents of which are incorporated herein by reference.

### BACKGROUND OF THE INVENTION

1. Field of the Invention

The present invention relates to a network function virtualization method and an apparatus using the same.

2. Description of the Related Art

As semiconductor technologies advance, computer processor performance is highly improved, and therefore simultaneous operations of a single server have increased due to advancement of a multi-core process technology.

Meanwhile, in a private data center of a corporate or finance sector, at least tens or at best hundreds of servers are installed to provide services for the corporate or financial sector (corporate finance, financial services, securities services, etc.)

Further, in internee data centers (IDCs), hundreds or thousands of serves are installed in one location to stably provide various kinds of services (web server, mail server, file server, video server, cloud server, etc.) to respective different users.

Accordingly, a corporate operator or Internet service provider needs integrated operation of the servers to reduce cost and simpler management thereof, and needs for control of large-scale multi-processors and cluster devices such as server storage or render farm have been raised.

In addition, specific operating system-dependent application programs are required to be run on different hardware or different operating systems.

In order to satisfy the above-described requirements, a concept of server virtualization has emerged.

In an environment where servers are virtualized, at least one or more virtual machines are present in a single server.

Such multiple virtual machines may share hardware resources of virtualized servers, such as CPU, memory, storage, network interfaces, etc.

A hypervisor may execute functions of creation, deletion, relocation, and resource management of the virtual machines in the server.

Further, the hypervisor allows the virtual machines to share network and storage.

For the storage, the hypervisor may be configured to assign logically or physically divided regions of the storage to each virtual machine such that the entire storage is shared by the virtual machines without interfering with each other.

However, for the network, the multiple (e.g., tens or hundreds) virtual machines installed in the single server generally share a few network devices.

When one or more virtual machines share a network device, the network device should allow the respective virtual machines to share the network without interfering with each other.

To solve these problems, a network virtualization technology has emerged.

One of major problems of the network virtualization technology is to logically differentiate a network data generated in one virtual machine from another network data generated in another virtual machine.

A first technology that addresses the problem of the network virtualization technology is a Layer-2 VLAN technology.

In Layer 2-VLAN technology, a closest-disposed layer-2 switch assigns independent VLAN IDs to each piece of network data that is generated at the respective virtual machines, such that the network data generated at one virtual machine is logically differentiated from another piece of network data generated at another virtual machine.

This technology is applied to almost all of layer-2 switches because it minimizes replacement of the legacy Layer 2 switches.

However, the Layer 2 VLAN technology has a limitation of providing a maximum of 4096 virtual machines (=2¹², because the VLAN ID is 12 bits).

In order to overcome such limitation of the Layer 2 VLAN technology, technologies such as a Q-in-Q and a MAC-in-MAC have emerged.

Technologies such as an edge virtual bridging (EVB) and high efficiency portable archive (H EPA) have emerged to solve the other limitation of the Layer 2 VLAN technology, that is, a network connection problem between the different virtual machines under the same hypervisor.

Another technology for embodying the network virtualization is a Layer 2 virtual network tag (VNTAG) technology.

The Layer 2 VNTAG technology adds an independently operating VNTAG to a closest Layer 2 switch to logically differentiate a piece of network data generated at one virtual machine from another piece of network data generated at another virtual machine.

The Layer 2 VNTAG technology may extend L2 bridges and recognize a virtual network.

Further, the Layer 2 VNTAG technology has a merit of individually configuring virtual interfaces as physical ports.

However, a function for processing the newly added VNTAG should be added to the hardware, and all of layer-2 switches should support VNTAG so as to use VNTAG.

Meanwhile, these technologies are L2 hardware-based ones, and a virtualization technology based on a software virtual switch (vSwitch) has emerged.

In vSwitch technology, a vSwitch is installed in a hypervisor that manages the virtual machine, so that flows generated from the virtual machines are switched to physical network interfaces.

In this case, the vSwitch inside of the hypervisor to which originating virtual machines belongs detects every flow that is newly generated in the originating virtual machines, and reports the detected flows to an openflow controller.

The openflow controller generates new flow entries and new flow IDs based on received flow information, and sets new flow entries and new IDs to destination servers.

Further, the openflow controller creates a switching table of the openflow switch, and transmits a message for instructing all of the openflow switches to add the new flow IDs.

Each openflow switch switches the network data that is encapsulated with the flow ID.

The vSwitch inside of the hypervisor to which the destination virtual machine belongs may decapsulate the network data that is encapsulated with the flow ID so as to extract the original network data.

Recently, together with the network virtualization technology, a network functions virtualization (NFV) technology has received attention.

Numerous hardware devices are present in a network that is operated by network operators, but the network operators may face various kinds of difficulties when introducing a new network service by using the legacy network devices.

That is, there are difficulties for launching the new service, such as a space problem, a power problem, forming a new configuration with the legacy devices that are complicatedly disposed, etc. for devices, and therefore lots of cost and time are required for the network operator to introduce the new service.

As such, when the network operator introduces the new service by using hardware-based complex devices, complicated technologies should be developed to design the new devices and to integrally operate the legacy and new devices in addition to the power and cost problem.

In addition, as lifecycles of the hardware-based devices become shorter, processes for buying, designing, integrating, and installing of the new hardware-based devices should be continued without involving increased sales.

A more critical problem is that, as such hardware lifecycles become shorter because improvement of the technologies and services speeds up, the additional hardware cost without involving the increased sales stymies introduction of new network services that can increase sales and innovational improvement into a network-based world.

The NFV technology refers to a technology in which the network operator utilizes an IT virtualization technology to design a network structure with industry standard servers, switches, and storage that are provided as devices at a user end.

That is, the NFV technology implements network functions as software that can be run in the existing industry standard servers and hardware.

The software of the NFV technology may be relocated at various positions of a network hierarchy if necessary.

Network devices to which the NFV technology is applicable are switching devices (BNG, CG-NAT, router, etc.), mobile network node devices (HLR/HSS, MME, SGSN, GGSN/PDN-GW, RNC, Node B, eNode B, etc.), home routers and set-top boxes, tunneling gateway devices (IPSec/SSL VPN gateways, etc.), traffic analyzers (DPI, QoE measurement, etc.), devices for service assurance, SLA monitoring, testing, and verification, NGN signaling devices (SBCs, IMS, etc.), network functions devices (AAA servers, policy control, billing platform, etc.), application-level optimization devices (CDNs, cache servers, load balancers, etc.), acceleration devices, and security devices (firewalls, virus detection system, intrusion detection system, spam protection, etc.), and so on.

The NFV technology is supported by a cloud computing technology and industry-standard high volume server technology.

At a core of the cloud computing technology is a technology in which the hypervisor and the virtual Ethernet switch (vSwitch) is used to virtualize the hardware, such that traffic between the virtual machines and the physical interfaces are connected.

With respect to communication centric functions, the cloud computing technology utilizes an ultra-high speed multicore CPU with high I/O bandwidth and a smart Ethernet NIC card that supports load sharing and TCP off-loading, thereby allowing data to be directly routed to the memories of the virtual machines.

Further, the cloud computing technology may use a polling mode Ethernet driver (LINUX NAPI or Intel PDK), not an interrupt-based Ethernet driver, thereby allowing high performance data processing.

Further, a cloud infra utilizes auto-installation of the virtual devices, resource management for exactly assigning the virtual devices to a CPU core, memories, and interfaces, re-installation of the faulty virtual machines, and orchestration and management mechanisms applicable to snapshots of VM status and relocation of the VMs, thereby improving availability and accessibility of the resources.

Finally, open application programming interfaces (APIs) (Openflow, OpenStack, OpenNaaS, OGF's NSI, etc.) may provide additional integration between the NFV and the cloud infrastructure.

In the industry standard high volume server technology, use of the industry standard high volume servers is a key factor of the NFV technology in an economic point of view.

The NFV technology utilizes economy of scale in the IT industry.

The industry standard high volume servers are configured by standardized IT products (e.g., x86 type CPUs) of which as many as millions sell.

For the industry standard high volume server using the standardized IT products, there are rival suppliers for server parts.

Because ASIC development cost increases in geometrical progression, companies using the ASIC-based hardware may fall behind in competition for developing devices compared with the ones using general purpose processors.

From now on, it is anticipated that the ASIC-based hardware will find its way only in exclusive ultra-high speed and high-performance products.

Numerous technical obstacles are ahead of the NFV technology.

First, there is portability/interoperability issue.

When different products, which are manufactured by different companies, are used in data centers with respective different environments, there should be no problem for them to be installed for the network functions in the respective environments and to be operated in the virtual devices

One technical object to be solved is defining of integrated interfaces by clearly dividing network software.

Another technical object is to resolve a performance trade-off issue.

The virtualization of network functions may involve performance deterioration because it is based on the industry standard hardware.

Accordingly, the virtualization of network functions should use a suitable hypervisor and the latest software technologies, such that the performance deterioration is minimized, thereby minimizing delay and processing overheads, while increasing throughput.

The other technical object is migration and coexistence of and compatibility with legacy platforms.

The NFU devices should necessarily co-exist with the legacy network devices, and have compatibility with legacy systems such as element management systems (EMSs), network management systems (NMSs), and OSS/BSS.

A further technical object involves management and orchestration issues.

The NFU technology requires integrated management and an orchestration structure.

In the NFU technology, the software network devices should be operated as the standardized infrastructure according to a well-defined, standardized, and abstracted specification through flexibility of software-based generic technologies.

This will reduce the cost and time to integrate the new virtual devices in network operating environments.

The next technical object deals with automation issues.

The NFV technology may be extensively used only when all of the network functions are automated.

Accordingly, automation is a key factor for success.

The next technical object deals with security and resilience issues.

The NFV technology to be introduced should guarantee no impairment of security, resilience, and availability of the network.

The NFV technology is likely to regenerate the network functions even when the devices are faulty, thereby improving the resilience and availability of the network.

The virtual devices should be as safe as the real devices if the infrastructure remains intact, particularly if the hypervisor and a configured value of the hypervisor are normal.

The network operator may devise a tool for controlling and checking the configured value of the hypervisor.

Further, the network operator may request the hypervisor and the virtual devices that are authenticated.

The next technical object deals with network stability issues.

Ensuring network stability means a state of the numerous virtual devices causing no influence to each other when they are managed and orchestrated between the respective different hardware manufacturers and hypervisors.

This is very important especially when the virtual functions are reconfigured due to hardware or software faults or when the virtual functions are relocated due to a cyber-attack.

The next technical object deals with simplicity issues.

This means that an operation of the virtual network platform should be simpler than that of the legacy devices.

Currently, the network manager is mainly focused on maintaining continuous support for the sales, production, and service and making the operation of the network simpler for the excessively complicated network platforms and the support systems that have evolved as the network technologies have advanced for the past tens of years.

The next technical object deals with integration issues.

Smooth integration of the plurality of virtual devices into the legacy industry standard high volume server and the hypervisor is one of the most important technical objects of the NFV technology.

The network operator should not incur critical integration costs when the servers, hypervisors, and virtual devices are mixedly used.

Among the above-described attempts to solve the technical objects of the NFC technology, a CHANGE project uses a Flowstream platform to solve the performance issue.

In the Flowstream platform, commercial hardware is used to process the flows.

In addition, a programmable switch is used to switch traffic to a module host for executing the network functions.

The traffic delivered to the module host from the switch may be switched by a user-definable process function that can be executed in the module host.

In the Flowstream platform, netmap, ClickOS, and FlowOS technologies are used to solve performance issues of the module host.

The netmap technology is an existing technology, which is further improved in the CHANGE project.

netmap is a framework for processing a user level of data at a high speed.

netmap ensures security in a user space and allows direct high-speed access of a ring buffer of NIC so as to remove unnecessary things in a common data stack.

netmap may exhibit performance of processing 1.4 million pieces if data every second in the CPU core that is operated at 900 MHz.

ClickOS is a structure in which a Click software router and MiniOS are combined to each other.

ClickOS may install lightweight virtual machines that are executable in legacy hypervisors (Xen and the like).

ClickOS allows a click (i.e., one of network functions as a module router) to be operated at an OS level, such that it ensures separation of levels between click modules, as seen in Xen, and allows several users to share the same hardware.

Better performance may be provided through ClickOS.

FlowOS is a kernel module for processing IP data that are received from NIC.

FlowOS creates a common virtual queue for each flow, and sends the received IP data to the virtual queue to which the IP data belongs.

One flow may maintain several data stream virtual queues, each of which corresponds to one protocol (e.g., IP, TCP, UDP, etc.).

Processing modules are kernel modules, which are connected to a single flow and processes data that belongs to the corresponding flow.

The respective processing modules are operated for specific layers, and generate corresponding processing kernel modules for each data processing.

FlowOS may consist of a classifier, a merger, a flow controller, and a processing pipeline.

The classifier is at a position where traffic is received, and delivers IP data to the appropriate flow according to rules that are set by the flow controller.

The merger is at a position where traffic is outputted, and reassembles IP data to deliver it to the output interface.

The flow controller creates respective queues for each protocol of the flows and manages the queues.

Further, the flow controller adds and deletes the flows, modifies definition of the flows, and serves to dynamically connect the processing modules to the flows or to disconnect the processing modules therefrom.

Further, the flow controller is responsible for communicating with other elements of the network (flow transmitters, flow receivers, and the other party flow processing platforms, etc.).

In the Flowstream platform, these three technologies (netmap, ClickOS, and FlowOS) are configured to be used in parallel and to complement each other.

netmap and ClickOS may be simultaneously operated in ClickOS to ensure better independence.

FlowOS may be implemented by using netmap to use a high speed data path processing technology.

The Flowstream platform has shown possibility of NFV concept by using netmap and ClickOS but significantly Jacks generality due to use of modified kernel mode software.

Further, in the case of ClickOS, available features are limited and scalability is not so good, thereby failing to satisfy diversity that is required by NFV.

Similarly, FlowOS uses multiple virtual queues at kernel levels to process the flows per protocol in parallel but performances of the classifier and the merger are important at the kernel level while effects of parallel-processing are not so clear.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a network functions virtualization apparatus capable of providing network functions according to attributes of flows and a method using the same.

An exemplary embodiment of the present invention provides a network function virtualization method capable of applying virtualized network functions to flows. The network function virtualization method may include: receiving the flows; switching the flows to at least one network function virtual machine according to a switching table of a network function flow switch; and applying the virtualized network functions to the flows.

The network function virtualization method may further include: receiving a flow table that is updated based on flow information of a new flow, which is generated from the virtual machine; and updating the switching table according to the flow table.

The network function virtualization method may further include checking a data attribute or service attribute of the flow after the receiving the flow, wherein the switching of the flow switches the flow to the at least one network function virtual machine according to the switching table based on the data attribute or service attribute.

The switching of the flow may further include switching the flow according to a service attribute of the at least one network function virtual machine.

The switching of the flow according to the service attribute of the at least one network function virtual machine may include: assigning a highest priority to a flow having a service attribute of “server-server” if a service attribute of the at least one network function virtual machine is “server-server”; and assigning a highest priority to a flow having a service attribute of “subscriber-server” if a service attribute of the at least one network function virtual machine is “subscriber-server”.

The switching of the flow according to the service attribute of the at least one network function virtual machine may include: assigning a highest priority to the flow having a service attribute of “real-time QoS” when a service attribute of the at least one network function virtual machine is “real-time service”; and assigning a highest priority to the flow having a service attribute of “delay sensitive QoS” when a service attribute of the at least one network function virtual machine is “delay sensitive service”.

The applying of the virtualized network functions may include virtually applying a dynamic host configuration protocol (DHCP) function, a network address translation (NAT) function, a firewall function, a deep packet inspection (DPI) function, or a load balancing function to the flow.

The network function virtualization method may include: analyzing a first flow that is applied with the virtualized network functions; and switching the first flow to the virtual machine or the other virtual machine that is different from the virtual machine.

The analyzing of the first flow may include: extracting first flow information of the first flow and determining whether the first flow is a new one or not, based on the first flow information; receiving a flow table that is updated based on the first flow information when the first flow is the new one; and updating the switching table based on the updated flow table.

The network function virtualization method may further include storing the first flow information in a flow table cache.

Another exemplary embodiment of the present invention provides a network function virtualization device for applying virtualized network functions to flows. The, network function virtualization device may include: at least one network function virtual machine configured to apply virtualized network functions to the flow; and a network function flow switch configured to receive the flow and to switch the flow to the at least one network function virtual machine according to a switching table.

The network function virtualization device may further include a network function agent configured to receive the flow table updated according to the flow information of the new flow, which is generated from the virtual machine, and to update the switching table.

The network function flow switch may be configured to check a data attribute or service attribute of the flow and to switch the flow to the at least one network function virtual machine according to the switching table based on the data attribute or service attribute.

The network function flow switch may be configured to switch the flow according to the service attribute of the at least one network function virtual machine.

The network function flow switch may be configured to assign highest priorities to a flow having a service attribute of “server-server” when a service attribute of the at least one network function virtual machine is “server-server” and to a flow having a service attribute of “subscriber-server” when a service attribute of the at least one network function virtual machine is “subscriber-server”.

The network function flow switch may be configured to assign highest priorities to a flow having a service attribute of “real-time QoS” when a service attribute of the at least one network function virtual machine is “real-time service” and to a flow having a service attribute of “delay-sensitive QoS” when a service attribute of the at least one network function virtual machine is “delay-sensitive service”

The at least one network function virtual machine may be configured to virtually apply a dynamic host predetermined protocol (DHCP) function, a network address translation (NAT), a firewall function, a deep packet inspection (DPI), or a load balancing function to the flow.

The network function flow switch may be configured to analyze a first flow that is applied with the virtualized network function and to switch the first flow to the virtual machine or the other virtual machine that is different from the virtual machine.

The network function flow switch may be configured to extract first flow information of the first flow and to determine whether the first flow is a new one based on the first flow information, and the network function agent is configured to receive the flow table that is updated based on the first flow information when the first flow is the new one and to update the switching table based on the updated flow table.

The network function flow switch may be configured to store the first flow information in a flow table cache.

### BRIEF DESCRIPTION OF THE DRAWINGS

FIG. 1 illustrates a network functions virtualization system according to an exemplary embodiment of the present invention.

FIGS. 2A and 2B are flowcharts illustrating a processing method of an ingress flow according to an exemplary embodiment of the present invention.

FIGS. 3A and 3B are flowcharts illustrating a processing method of an egress flow according to the exemplary embodiment of the present invention.

FIG. 4 illustrates a network functions virtualization system according to another exemplary embodiment of the present invention.

FIGS. 5A, 5B, and 5C are flowcharts illustrating a processing method of an ingress flow according to another exemplary embodiment of the present invention.

FIGS. 6A and 6B are flowcharts illustrating a processing method of an egress flow according to another exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive, and like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In addition, the terms “-er”, “-or”, “module”, and “block” described in the specification mean units for processing at least one function and operation, and can be implemented by hardware components or software components, and combinations thereof.

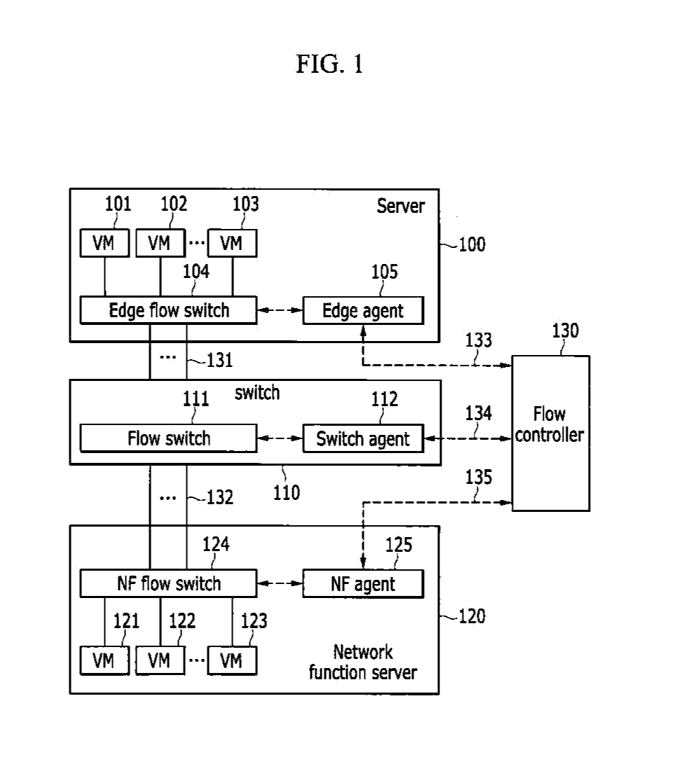

FIG. 1 illustrates a network functions virtualization system according to an exemplary embodiment of the present invention.

Referring to FIG. 1, a network functions virtualization (NFV) system according to an exemplary embodiment of the present invention includes a server 100, a switch 110, a network function server 120, and a flow controller 130.

The server 100 includes an edge flow switch 104 and an edge agent 105, and the edge flow switch 104 is connected to a plurality of virtual machines 101 to 10n that are included in the server.

The edge flow switch 104 is connected to the switch 110 through at least one network interface 131.

The edge agent 105 is connected to the flow controller 130 through a management and control interface 133.

The virtual machines 101 to 10n of the server 100 refer to an operating system (OS) (LINUX, NetBSD, FreeBSD, Solaris, Windows, etc.), which is operated on logical hardware (virtual CPU, virtual memory, virtual storage, virtual network interface, etc.) that the hypervisor provides.

The virtual machines 101 to 10n generate data flows according to services (web server, file server, video server, cloud server, corporate finance, financing, securities, etc.) that the corresponding virtual machines provide, and each data flow has a different quality of service (QoS) requirement.

The edge flow switch 104 analyzes the data flow that is generated in the virtual machines 101 to 10n, and delivers a new data flow to the edge agent 105.

The edge flow switch 104 processes the data flow, other than the new data flow, according to a switching table in the edge flow switch 104.

The edge agent 105 updates new flow information based on received information from the flow controller 130.

In this case, the edge agent 105 may periodically update the switching table, a virtual machine table, etc. through the flow controller.

The periodically updated virtual machine table may include network information and QoS information of the services (real-time/non-real-time service, high bandwidth service, low bandwidth service, delayed sensitive/insensitive service, directions of service data (subscriber-server, server-server), virtual machine bandwidth information, etc.), which the virtual machines provides, about each virtual machine.

The periodically updated switching table may include network information, operation information (forwarding, drop, edge agent transfer, field correction, tunneling, etc.), and QoS information (real-time/non-real-time data, high bandwidth, low bandwidth, delayed sensitive/insensitive, secured/unsecured data, directions of service data (subscriber-server, server-server), etc.) about each flow.

The switch 110 includes a flow switch 111 and a switch agent 112.

The switch 110 is connected to the server 100 and the network function server 120 through one or more network interfaces 131 and 132.

The switch agent 112 is connected to the flow controller 130 through a management and control interface 134.

The switch 110 is connected to the server 100 through at least one network interface 131 of a L2 switch and/or a L3 switch.

The switch agent 112 updates the virtual machine table and the switching table of the switch 110 based on the new flow information that is received from the flow controller 130 through the management and control interface 134.

In this case, the switch agent 112 may periodically receive the new flow information from the flow controller 130.

The periodically updated virtual machine table may include network information and QOS information (real-time/non-real-time service, high bandwidth service, low bandwidth service, delayed sensitive/insensitive service, directions of service data (subscriber-server, server-server), virtual machine bandwidth information etc.) about each virtual machine.

The periodically updated switching table may include network information, operation information (forwarding, drop, edge agent transfer, field correction, directions of service data (subscriber-server, server-server) etc.), and QoS information of the services (real-time/non-real-time data, high bandwidth, low bandwidth, delayed sensitive/insensitive, and directions of service data (subscriber-server, server-server) etc.), which the virtual machines provide, about each flow.

The switch 110 receives the data flows that are generated from the virtual machines 101 to 10n through the L2 switch and/or the L3 switch.

The switch 110 analyzes the received data flows and extracts the flow information thereof.

Then, the switch 110 applies a QoS policy for the virtual machine and the flow to the data flow, based on the virtual machine network information of the switching table (IP address of the virtual machine, MAC address of the virtual machine, NAT conversion information of the virtual machine, bandwidth information of the virtual machine, etc.), which is updated in the switch agent 112, and the QoS information (real-time/non-real-time data, high bandwidth, low bandwidth, delay-sensitive/insensitive, directions of service data (subscriber-server, server-server), etc.).

Because the switch 110 periodically updates through the switch agent 112 the QoS information for all the flows in the switch as well as the network and QoS information for the virtual machines in the system, the switch 110 may provide an optimal QoS to each flow according to service types that the corresponding virtual machines provide.

In this case, the switch 110 may differentiate the direction of service data (subscriber-server or server-server) among the QoS information of each virtual machine, thereby managing QoS of the flows.

For example, the switch 110 may assign a high priority to any flow having a service attribute of “server-server” when a service attribute of the virtual machine is “server-server”, and the switch may assign a high priority to any flow having a service attribute of “subscriber-server” when a service attribute of the virtual machine is “subscriber-server”, thereby providing QoS to the service data.

Further, when a service attribute of the virtual machine is “real-time service”, the switch 110 may assign a high priority to any flow having a real-time QOS attribute among the data flows that are generated by the virtual machines, thereby providing QoS to the service data.

Further, when a service attribute of the virtual machine is “delay-sensitive service”, the switch 110 may assign a high priority to any flow having a delay-sensitive QOS attribute among the data flows that are generated by the virtual machines, thereby providing QoS to the service data.

The network function server 120 includes a network function flow switch 124 and a network function agent 125, and the network function flow switch 124 is connected to a plurality of network function virtual machines 121 to 12n that are included in the network function server.

Further, the network function flow switch 124 is connected to the switch 110 through at least one network interface 132.

In this case, the network function server 120 may be connected to the switch 110 through the L2 switch and/or the L3 switch.

In addition, the network function agent 112 is connected to the flow controller 130 through a management and control interface 135.

The network function flow switch 124 receives the data flows from the switch 110 through the L2 switch and/or the L3 switch.

The network function flow switch 124 analyzes the data flows that are received from the switch 110, and extracts the flow information thereof.

If the extracted flow information indicates a new data flow, the network function flow switch 124 delivers the received data flow to the network function agent 125.

However, if not, the network function flow switch 124 switches the received flow to the network function virtual machines 121 to 12n according to a switching table of the network function flow switch 124.

Further, the network function flow switch 124 analyzes the data flows that are received from the network function virtual machines 121 to 12n, and extracts the flow information thereof.

In this case, if the extracted flow information indicates a new data flow, the network function flow switch 124 delivers the received data flow from the network function virtual machines 121 to 12n to the network function agent 125.

However, if not, the network function flow switch 124 switches the received data flow according to the network function switching table to the switch 110 or the other network function virtual machines 121 to 12n.

The network function flow switch 124 adds the switching table, which is used for detecting the new data flow, to a switching table cache.

The network function flow switch 124 deletes the corresponding switching table in the switching table cache when the data flow ceases to exist.

The network function flow switch 124 may apply the same switching table of the same data flow, which is saved in the switching table cache, to the same data flow.

When the network function virtual machines 121 to 12n generate new data flows, each data flow may have different QoS requirements according to network functions.

Further, the network function flow switch 124 may assign different QoS priorities to the data flows according to the service attributes of the QoS information of each network function virtual machine, thereby managing QoS.

For example, the network function flow switch 124 may differentiate directional information of service data (subscriber-server or server-server), and may accordingly process the data flows.

The network function virtual machines 121 to 12n refer to modules for executing network functions (DHCP, NAT, Firewall, DPI, Load Balancing etc.) in an operating system (OS) (LINUX, NetBSD, FreeBSD, Solaris, Windows, etc.), which is operated on logical hardware (virtual CPU, virtual memory, virtual storage, virtual network interface, etc.) that the hypervisor provides.

In the exemplary embodiment of the present invention, a plurality of network function virtual machines are included in the network function server such that they can apply the network functions to the flows in parallel.

The network function virtual machines 121 to 12n may receive a data flow from the network function flow switch 124, process the data flow according to the network functions (DHCP, NAT, Firewall, DPI, Load Balancing etc.), and deliver a result thereof to the flow controller 130 through the network function agent 125.

Further, after processing the received data flow, the network function virtual machines 121 to 12n may generate a new flow and deliver the new flow to the network function flow switch 124.

The network function agent 125 is connected to the flow controller 130 through the management and control interface 135, and updates the new flow information.

Further, the network function agent 125 is periodically connected to the flow controller 130, and updates the switching table and the network function virtual machine table.

The periodically updated network function virtual machine table may include network information and QoS information of the network function services (real-time/non-real-time service, high bandwidth service, low bandwidth service, delayed sensitive/insensitive service, network function directions of service data (subscriber-server or server-server) and bandwidth information of the network function virtual machines, etc.), which the network function virtual machines 121 to 12n provides, about the respective network function virtual machines 121 to 12n.

The periodically updated switching table may include network information, operation information (forwarding, drop, edge agent transfer, field correction, tunneling, etc.), and QoS information (real-time/non-real-time data, high bandwidth, low bandwidth, delayed sensitive/insensitive, secured/unsecured data, directions of service data (subscriber-server, server-server), etc.) about each flow.

The network function flow switch 124 may differentiate directions of service data (subscriber-server or server-server) of the QoS information of the respective network function virtual machines 121 to 12n, thereby managing QoS of the flow.

For example, the network function flow switch 124 may assign a highest priority to any flow having a service attribute of “server-server” when a service attribute of the network function virtual machines 121 to 12n is “server-server”, and the network function flow switch may assign a highest priority to any flow having a service attribute of “subscriber-server” when the service attribute of the network function virtual machine is “subscriber-server”, thereby providing QoS to the service data.

Further, when service attributes of the network function virtual machines 121 to 12n are “real-time service”, the network function flow switch 124 may assign a high priority to any flow having a real-time QOS attribute among the data flows that are generated by the network function virtual machine, thereby providing QoS to the service data.

Further, when service attributes of the network function virtual machines 121 to 12n are “delay-sensitive service”, the network function flow switch 124 may assign a high priority to any flow having a delay-sensitive QOS attribute among the data flows that are generated by the network function virtual machine, thereby providing QoS to the service data.

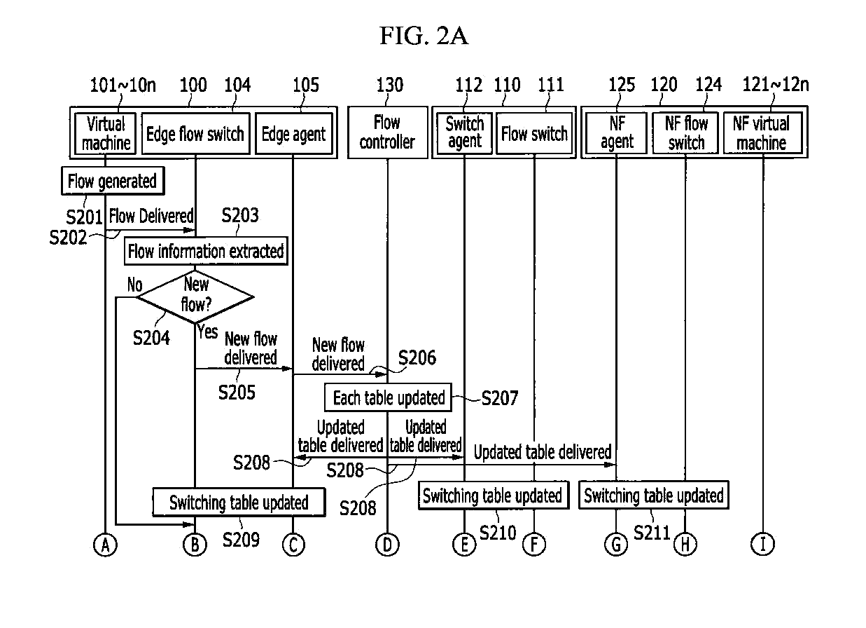

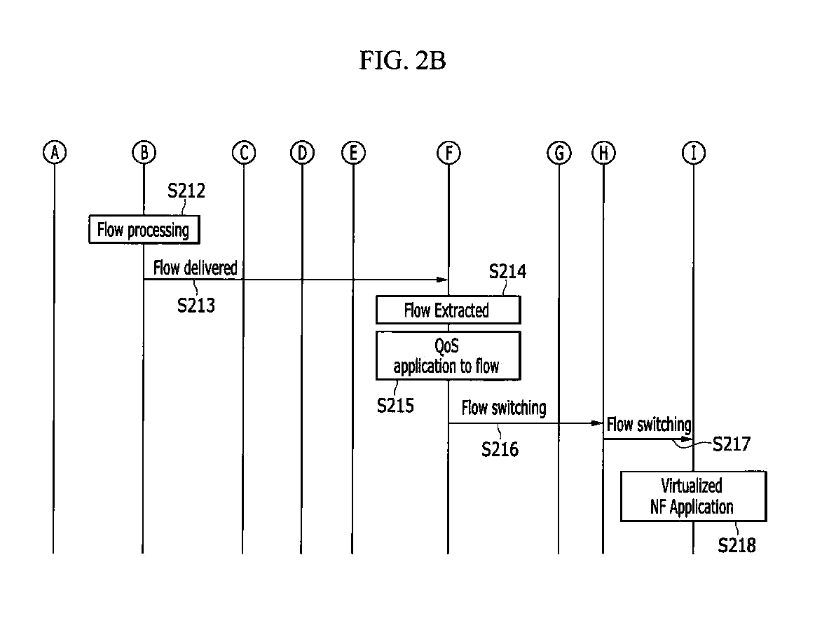

FIGS. 2A and 2B are flowcharts illustrating a processing method of an ingress flow according to the exemplary embodiment of the present invention.

Referring to FIGS. 2A and 2B, the virtual machines 101 to 10n included in the server 100 generate flows according to services (web server, mail server, file server, video server, cloud server, corporate finance, financing, securities, etc.) (S201), and deliver the flows to the edge flow switch 104 (S202).

The edge flow switch 104 analyzes the flow that is generated from the virtual machines 101 to 10n and extracts flow information thereof (S203), and determines whether the flow is a new one or not (S204).

When the flow generated from the virtual machines 101 to 10n is the new flow, the edge flow switch 104 delivers the flow information of the new flow (the new flow information) to the edge agent 105 (S205).

Then, the edge agent 105 delivers the new flow information to the flow controller 130 (S206).

Next, the flow controller 130 generates virtual flow information and network function information through the new flow information, and updates a flow table of the flow controller 130 (S207).

In this case, the flow table may include the switching table and the network function table.

Next, the edge agent 105 receives the updated flow table of the flow controller 130 (S208), and updates the switching table of the edge flow switch 104 according to the updated flow table (S209).

Similarly, the switch agent 112 updates the switching table of the switch 110 according to the updated flow table of the flow controller 130 (S210).

Similarly, the network function agent 125 updates the switching table of the network function flow switch 124 according to the updated flow table of the flow controller 130 (S211).

Next, the edge flow switch 104 processes the flow that is generated from the virtual machines 101 to 10n of the server 100 (S212), and delivers the flow to the switch 110 through at least one network interface 131 via the L2 switch and/or the L3 switch (S213).

The flow switch 111 analyzes the flow that is generated from the virtual machines 101 to 10n, and extracts flow information (S214).

The flow switch 111 finds network information (IP address of the virtual machine, MAC address of the virtual machine, NAT conversion information of the virtual machine, virtual machine bandwidth information, etc.) and QOS information (real-time/non-real-time data, high/low bandwidth, delayed sensitive/insensitive, directions of service data (subscriber-server, server-server) etc.) of the virtual machine of the switching table, and QoS information of the flow (real-time/non-real-time data, high/low bandwidth, delayed sensitive/insensitive, secured/unsecured data service, directions of data (subscriber-server, server-server) etc.) from the switching table by using the extracted flow information and then determines a QoS policy for the received flow based on the network information, the QoS information and the QoS information of the flow.

Then, the flow switch 111 applies the QoS policy for the flow that it has been determined (S215).

Further, the switch 110 switches the data flow that is received from the server 100 according to the updated switching table (S216).

If required to perform network functions virtualization for the corresponding data flow, the switch 110 switches the flow to the network function server 120 according to the switching table.

If not, the switch 110 switches the flow to the other server 100 according to the switching table.

Next, the network function flow switch 124 of the network function server 120 checks a data attribute (image data, voice data, text data, etc.) or service attribute (real-time service, delay-sensitive service etc.) of the received flow (S217).

Then, the network function flow switch 124 switches the flow to the network function virtual machines 121 to 12n that can execute the virtual network functions according to the switching table of the network function flow switch 124 based on the data attribute or service attribute of the flow (S218).

The network function virtual machines 121 to 12n apply the virtualized network function to the data flow that is received from the network function flow switch 124 (S219).

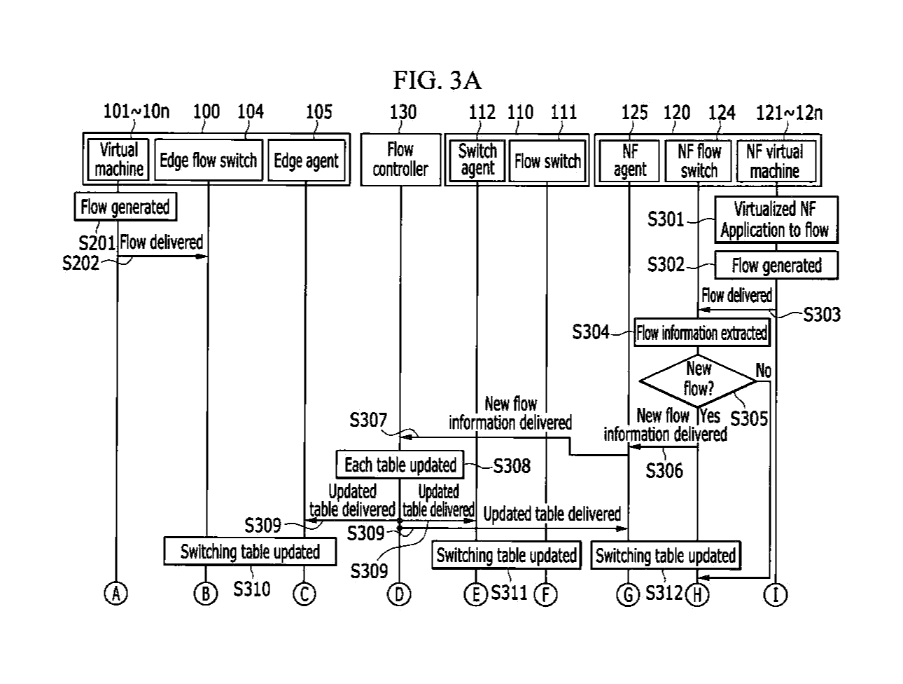

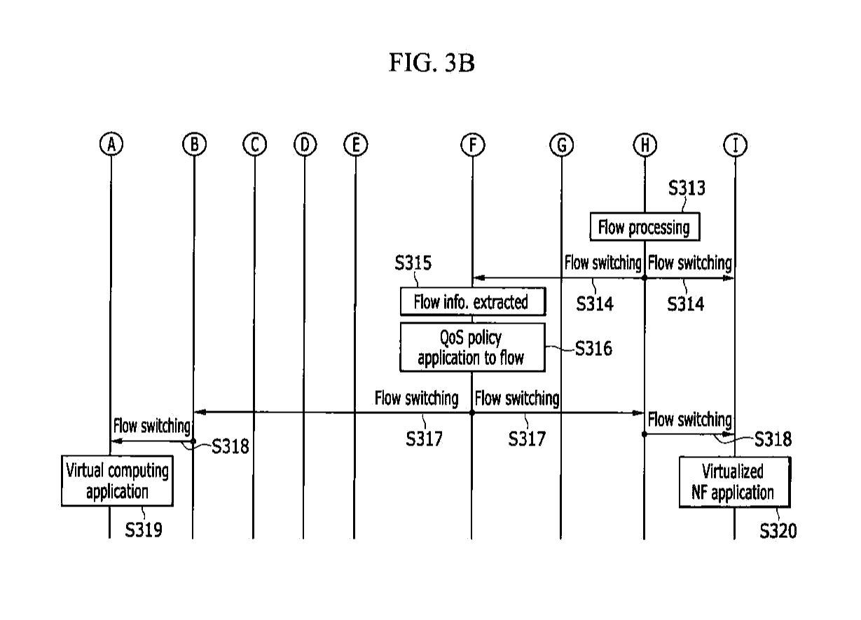

FIGS. 3A and 3B are flowcharts illustrating a processing method of an egress flow according to the exemplary embodiment of the present invention.

The network function virtual machines 121 to 12n apply the virtualized network function to the data flow that is received from the network function flow switch 124 (S301).

Then, the network function virtual machines 121 to 12n generate a flow according to the virtualized network function (DHCP, NAT, Firewall, DPI, Load Balancing etc.) (S302), and deliver the flow to the network function flow switch 124 (S303).

The network function flow switch 124 analyzes the flow that is generated from the network function virtual machines 121 to 12n, and extracts the flow information thereof (S304).

Next, the network function flow switch 124 checks whether the flow generated from the network function virtual machines 121 to 12n is a new one or not (S305) according to the extracted flow information.

If the flow generated from the network function virtual machines 121 to 12n is the new one, the network function flow switch 124 delivers the flow information of the extracted new flow (new flow information) to the network function agent 125 (S306).

The network function agent 125 delivers the new flow information to the flow controller 130 (S307).

The flow controller 130 generates virtual flow information and network function information about the new flow based on the corresponding new flow information, updates the switching table and the network function table of the flow controller 130 (S308), and delivers the updated tables to the edge agent 105, the switch agent 112, and network function agent 125 (S309).

The edge agent 105 updates the switching table of the edge flow switch 104 according to the switching table that is updated by the flow controller 130 (S310).

The switch agent 112 updates the switching table of the switch 111 according to the virtual machine switching table that is updated by the flow controller 130 (S311).

The network function agent 125 updates the switching table of the network function flow switch 124 according to the virtual machine switching table and the network function table that are updated by the flow controller 130 (S312).

The network function flow switch 124 processes the data flow generated from the network function virtual machines 121 to 12n according to the switching table of the network function flow switch 124 (S313), and delivers the data flows to the switch 110 or the other network function machines 121 to 12n (S314).

The switch 110 analyzes the data flow that is received from the network function flow switch 124, and extracts flow information (S315).

The flow switch 111 of the switch 110 finds network information (IP address of the virtual machine, MAC address of the virtual machine, NAT conversion information of the virtual machine, virtual machine bandwidth information, etc.) and QOS information (real-time/non-real-time data, high/low bandwidth, delayed sensitive/insensitive, directions of service data (subscriber-server, server-server) etc.) of the virtual machine, and QoS information of the flow (real-time/non-real-time data, high/low bandwidth, delayed sensitive/insensitive, secured/unsecured data service, directions of data (subscriber-server, server-server) etc.) from the switching table by using the extracted flow information and then determines a QoS policy for the received flow based on the network information, the QoS information and the QoS information of the flow.

Then, the flow switch 111 applies the QoS policy that is determined to the received flow (S316).

Next, the switch 110 switches the data flow that is received through the network function flow switch 124 according to the switching table (S317).

If required to apply network functions virtualization to the corresponding data flow, the switch 110 switches the flow to the network function server 120 according to the switching table.

If not, the switch 110 switches the flow to the other server 100 according to the switching table.

The edge flow switch 104 of the server 100 switches the data flow that is delivered through the switch 110 to the virtual machines 101 to 10n, which can execute a virtual computing function, according to the switching table of the edge flow switch 104 (S318).

Alternatively, the network function flow switch 124 of the network function server 120 may switch the data flow that is received through the switch 110 to the network function virtual machines 121 to 12n, which can execute the virtual network functions according to the switching table of the network function flow switch 124.

Next, the virtual machines 101 to 10n apply the virtual computing function to the data flow that is received from the edge flow switch 104 (S319).

Then, the network function virtual machines 121 to 12n apply the virtual network function to the data flow that is received from the network function flow switch 124 (S320).

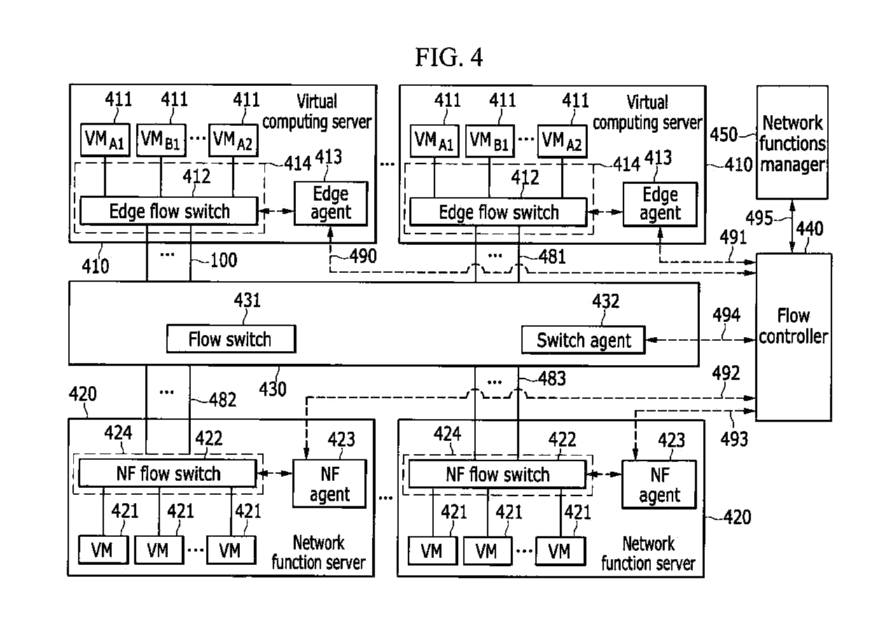

FIG. 4 illustrates a network function virtualization system according to another exemplary embodiment of the present invention.

Referring to FIG. 4, another exemplary embodiment of the present invention provides a network function virtualization system, including: a plurality of virtual computing servers 410, a plurality of virtual network function servers 420, a switch 430, a flow controller 440, and a network functions manager 450.

The plurality of virtual computing servers 410 are connected to the switch 430 through one or more network interfaces 480 and 481 via an L2 switch and/or an L3 switch.

In addition, the plurality of virtual computing servers 410 are connected to the flow controller 440 through management and control interfaces 490 and 491.

The switch 430 includes flow switch 431 and switch agent 432. The switch 430 is connected to the flow controller 440 through a switch management and control interface 494.

The plurality of network function servers 420 are connected to the switch 430 through one or more network interfaces 482 and 483 via the L2 switch and/or the L3 switch. Further, the plurality of network function servers 420 are connected to the flow controller 440 through management and control interfaces 492 and 493.

The flow controller 440 is connected to the network functions manager 450 including a man-machine interface (MMI), a virtual machine manager, or a cloud operating system (OS) through a management and control interface 495.

Each of the plurality of virtual computing servers 410 includes a plurality of virtual machines 411, an edge flow switch 412, an edge agent 413, and a hypervisor 414.

The plurality of virtual machines 411 refer to an operating system (OS) (LINUX, NetBSD, FreeBSD, Solaris, Windows, etc.), which is operated on logical hardware (virtual CPU, virtual memory, virtual storage, virtual network interface, etc.) that the hypervisor provides.

Each virtual machine 411 generates a data flow according to a service (web server, file server, video server, cloud server, corporate finance, financing, securities, etc.) that the corresponding virtual machine provides, and each data flow has different QoS priority.

The edge flow switch 412 analyzes the data flow that is generated in the plurality of virtual machines, and delivers the data flow, if the data flow is a new one, to the edge agent 413.

If not, the edge flow switch 412 processes the flow according to the switching table.

The edge agent 413 is connected to the flow controller 440 through the management and control interfaces 490 and 491, and updates new flow information.

In this case, the edge agent 413 is periodically connected to the flow controller 440, and updates information about the switching table and the virtual machine table.

The periodically updated virtual machine table may include network information, QoS information of the service (real-time/non-real-time service, high bandwidth service, low bandwidth service, delayed sensitive/insensitive service, directions of service data (subscriber-server, server-server), virtual machine bandwidth information, etc.), which the virtual machines provide, and bandwidth information about each virtual machine 411.

The periodically updated switching table may include network information, operation information (forwarding, drop, edge agent transfer, field correction, tunneling, etc.), and QoS information (real-time/non-real-time data, high bandwidth, low bandwidth, delayed sensitive/insensitive, secured/unsecured data, directions of service data (subscriber-server, server-server), etc.) about each flow.

The hypervisor 414 provides logical hardware (virtual CPU, virtual memory, virtual storage, virtual network interface), which is virtualized physical hardware (CPU, memory, storage, network interface, etc.), to the plurality of virtual machines 411.

Further, the hypervisor 414 directly executes management of the virtual machine (creation, change, removal, transfer, etc.) and a server resource management function according to management commands of the virtual machines 411 that are received from the flow controller 440, and reports the result of the execution to the flow controller 440.

Each network function server 420 includes a plurality of network function virtual machines 421, a network function flow switch 422, a network function agent 423, and a hypervisor 424.

The network function flow switch 422 receives data flows from the switch 430 through one or more network interfaces 482 and 483 via the L2 switch and/or the L3 switch.

Then, the network function flow switch 422 analyzes the flow that is received from the switch 430 to extract flow information.

If the received flow is a new one, the network function flow switch 422 delivers the received data flow to the network function agent 423.

If not, the network function flow switch 422 switches the received data flow to the network function virtual machine 421 according to the network function switching table of the network function flow switch 422.

Further, the network function flow switch 422 analyzes the flow that is received from the network function virtual machine 421 to extract flow information.

If the data flow is a new one, the network function flow switch 422 delivers the received data flow to the network function agent 423.

If not, the network function flow switch 422 switches the received data flow to the switch 430 or the other network functions machine 421 according to the network function switching table of the network function flow switch 422.

In this case, the network function flow switch 422 adds the switching table used for detecting the new data flow to a switching table cache.

The network function flow switch 422 deletes the corresponding switching table in the switching table cache when the data flow ceases to exist.

The network function flow switch 422 may apply the same switching table of the same data flow, which is saved in the switching table cache, to the same data flow.

When the network function virtual machines 421 generate new data flows, the data flows may respectively have different QoS requirements according to executed network functions.

The network function virtual machines 421 refer to modules for executing network functions (DHCP, NAT, Firewall, DPI, Load Balancing etc.) in an operating system (OS) (LINUX, NetBSD, FreeBSD, Solaris, Windows, etc.), which is operated on logical hardware (virtual CPU, virtual memory, virtual storage, virtual network interface, etc.) that the hypervisor provides.

In the exemplary embodiment of the present invention, the plurality of network function virtual machines are included in the network function server, and may apply the network functions to the flow in parallel.

The network function virtual machines 421 may receive data flows from the network function flow switch 422, process the data flow according to the network functions (DHCP, NAT, Firewall, DPI, Load Balancing, etc.), and deliver a result thereof to the flow controller 130 through the network function agent 423.

Further, after processing the received data flow, the network function virtual machines 421 may generate a new flow and deliver the new flow to the network function flow switch 422.

The hypervisor 424 provides logical hardware (virtual CPU, virtual memory, virtual storage, virtual network interface), which is virtualized physical hardware (CPU, memory, storage, network interface etc.), to the plurality of virtual machines 421.

Further, the hypervisor 424 directly executes management of the network function virtual machine (creation, change, removal, transfer, etc.) and a network function server resource management function according to management commands of the virtual machines 421 that are received from the flow controller 440, and reports the result of the execution to the flow controller 440.

The network function agent 423 is connected to the flow controller 440, and updates the new flow information.

The network function agent 423 is periodically connected to the flow controller 440, and updates information about the switching table and the network function virtual machine table.

The periodically updated network function virtual machine table may include network information and QoS information of the service (real-time/non-real-time service, high bandwidth service, low bandwidth service, delayed sensitive/insensitive service, directions of service data (subscriber-server, server-server), network function virtual machine bandwidth information, etc.), which the network function virtual machines provide, about each network function virtual machine.

The periodically updated switching table may include network information, operation information (forwarding, drop, edge agent transfer, field correction, tunneling, etc.), and QoS information (real-time/non-real-time data, high bandwidth, low bandwidth, delayed sensitive/insensitive, secured/unsecured data, directions of service data (subscriber-server, server-server), etc.) about each flow.

The network function flow switch 422 differently processes the flows by differentiating the directions of service data (subscriber-server or server-server) among the QoS information of the respective network function virtual machines 421, thereby being capable of managing QoS.

For example, the network function flow switch 422 may assign a high priority to any flow having a service attribute of “server-server” when a service attribute of the network function virtual machine 421 is “server-server”, and may assign a high priority to any flow having a service attribute of “subscriber-server” when the service attribute of the network function virtual machine 421 is “subscriber-server”, thereby providing appropriate QoS to the service data.

Further, when a service attribute of the network function virtual machine 421 is “real-time service”, the network function flow switch 422 may assign a high priority to any flow having a real-time QOS attribute among the data flows of the network function virtual machines 421, thereby providing better QoS to the service data.

Further, when a service attribute of the network function virtual machine 421 is “delay-sensitive service”, the network function flow switch 422 may assign a high priority to any flow having a delay-sensitive QOS attribute among the data flows of the network function virtual machines, thereby providing appropriate QoS to the service data.

The switch 430 is connected to the server 410 through one or more network interfaces 480 and 481 via the L2 switch and/or the L3 switch.

Further, the switch 430 is connected to the flow controller 440 through the management and control interface 494.

In addition, a switch agent 432 included in the switch 430 periodically updates the virtual machine table and the switching table of the switch 430, based on the new flow information that is received from the flow controller 440 through the management and control interface 494.

The periodically updated virtual machine table may include network information and QOS information (real-time/non-real-time service, high bandwidth service, low bandwidth service, delayed sensitive/insensitive service, directions of service data (subscriber-server, server-server), virtual machine bandwidth information etc.) about each virtual machine.

The periodically updated switching table may include network information, operation information (forwarding, drop, edge agent transfer, field correction for the respective flows, directions of service data (subscriber-server, server-server) etc.), and QoS information of the services (real-time/non-real-time data, high bandwidth, low bandwidth, delayed sensitive/insensitive, directions of service data (subscriber-server, server-server) etc.), which the virtual machines provides, about each flow.

The switch 430 receives the flow that is generated from the virtual machines 411 of the server 410 through one or more network interfaces 480 and 481 via the L2 switch and/or the L3 switch.

Further, the switch 430 analyzes the data flow that is generated from the virtual machines 411, and extracts the flow information.

Further, the switch 430 applies a QoS policy to the data flow based on network information (IP address of the virtual machine, MAC address of the virtual machine, NAT conversion information of the virtual machine, virtual machine bandwidth information etc.), which are updated by the switch agent 425, and QoS information (real-time/non-real-time data, high/low bandwidth, delayed sensitive/insensitive, directions of service data (subscriber-server, server-server) etc.) about the virtual machines.

Because the switch 430 periodically updates the QoS information about all the flows in itself through the switch agent 432 as well as the QoS information and the network information about the virtual machines included in the system, it may provide optimal QoS to each flow according to the service types that the corresponding virtual machines provide.

The switch 430 differently processes the flows by differentiating the directions of service data (subscriber-server or server-server) among the QoS information of each virtual machine, thereby being capable of managing QoS.

For example, the switch 430 may assign a high priority to any flow having a service attribute of “server-server” when a service attribute of the corresponding virtual machine is “server-server”, and may assign a high priority to any flow having a service attribute of “subscriber-server” when the service attribute of the corresponding virtual machine is “subscriber-server”, thereby providing optimal QoS to the service data.

Further, when a service attribute of the corresponding network function virtual machine is “real-time service”, the switch 430 may assign a high priority to any flow having a real-time QOS attribute among the data flows of the virtual machine, thereby providing optimal QoS to the service data.

Further, when a service attribute of the corresponding virtual machine is “delay-sensitive service”, the switch 430 may assign a high priority to any flow having a delay-sensitive QOS attribute among the data flows of the virtual machines, thereby providing optimal QoS to the service data.

The flow controller 440 may manage (create, change, delete, relocate, etc.) the virtual machines of the server according to MMI commands of a manager, commands of a virtual machine manager, or commands of a Cloud OS.

In addition, the flow controller 440 may transmit commands or server resource management commands to the hypervisor 414 of the server 410 through the management and control interfaces 490 and 491.

The hypervisor 414 may directly execute management operations (creation, change, removal, transfer, etc.) and server resource management functions according to the corresponding commands, and may deliver result information of the corresponding execution and the virtual machine information to the flow controller 440.

The flow controller 440 may deliver the result information of the executed command, which is received from the hypervisor 414, to the network function manager 450.

Further, the flow controller 440 delivers management command (creation, change, removal, transfer, etc.) or network function server resource management commands of the network function virtual machines 421 of the network function server 420 to the hypervisor 424 that is included in the network function server 420 according to MMI command of the manager, commands of the network functions manager 450, or commands of Cloud OS.

The hypervisor 424 included in the network function server 420 may directly execute management operations (creation, change, removal, transfer, etc.) and server resource management functions of the network function virtual machines according to the corresponding commands, and may deliver result information of the corresponding execution and the network function virtual machine information to the flow controller 440.

The flow controller 440 delivers the result to the network function manager 450.

Further, the flow controller 440 delivers the flow management command and information to the edge agent 413 that is included in the server 410.

The edge agent 413 directly executes the flow management function according to the corresponding command and updates the switching table and the virtual machine table, and delivers result information of the executed command to the flow controller 440.

Further, the flow controller 440 delivers the flow management command and the information through the switch management and control interface 494 to the switch agent 432 that is included in the switch 430.

The switch agent 432 directly executes the flow management function according to the corresponding command and updates the switching table and the virtual machine table, and delivers result information of the executed command to the flow controller 440.

The virtual machine table of the flow controller 440 may include network information and QoS information of the service, which the virtual machines provide (real-time/non-real-time service, high bandwidth service, low bandwidth service, delayed sensitive/insensitive service, directions of service data (subscriber-server or server-server), virtual machine bandwidth information, etc.) about each virtual machine.

The switching table of the flow controller 440 may include network information, operation information (forwarding, drop, edge agent transfer, field correction, tunneling, etc.), and QoS information (real-time/non-real-time data, high bandwidth, low bandwidth, delayed sensitive/insensitive, secured/unsecured data service, directions of data (subscriber-server or server-server), etc.) about the each flow.

The flow controller 440 delivers the management command (creation, change, removal, transfer, etc.) or network function server resource management command of the network function virtual machines 421 of the network function server 420 to the hypervisor 424 that is included in the network function server 420 through the management and control interfaces 492 and 493 according to the MMI command of the manger and the command of the network functions manager 450.

The hypervisor 424 included in the network function server 420 directly executes management operations (creation, change, removal, transfer, etc.) and the network function resource management function according to the corresponding command, and delivers result information of the executed command and the network function virtual machine information to the flow controller 440.

Further, the flow controller 440 delivers the network function flow management commands and the information through the network function server management and control interfaces 492 and 493 (and the like) to the network function server 420 that is included in the network function agent 423.

The network function agent 423 directly executes the network function flow management function according to the corresponding command and updates the switching table and the virtual machine table, and delivers result information of the executed command to the flow controller 440.

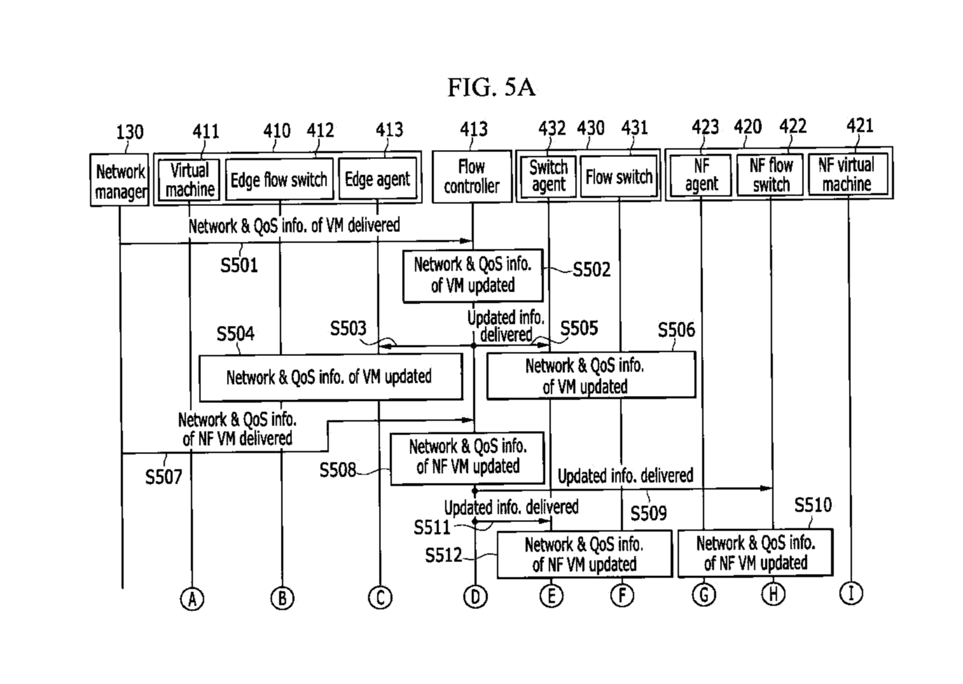

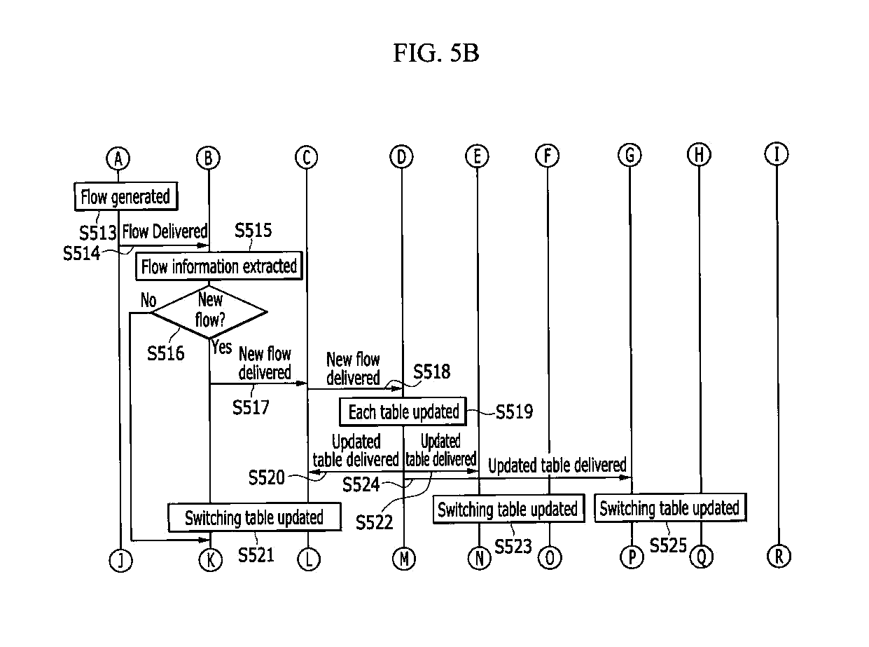

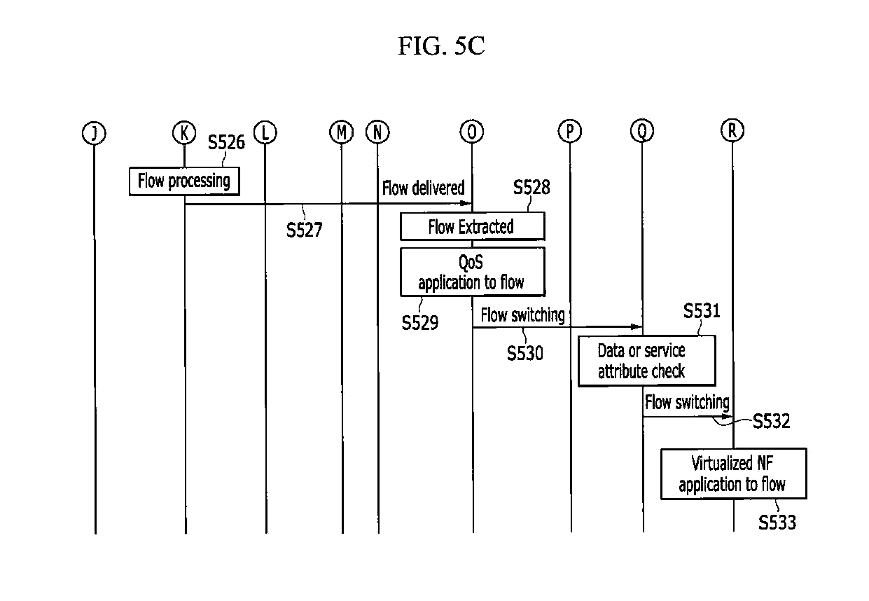

FIGS. 5A, 5B, and 5C are flowcharts illustrating a processing method of an ingress flow according to another exemplary embodiment of the present invention.

The network functions manager 450 including the MMI commands of the manager, the commands of the virtual machine manager, or Cloud OS may create the virtual machines 411 or relocate the virtual machines 411 to the other server 410 through the server 410 so as to provide the services (web server, mail server, file server, video server, cloud server, corporate finance, financing, securities, etc.).

Further, the network functions manager 450 may create the virtual machines 421 or relocate the virtual machines 421 to the other network function server through the network function server 420 so as to provide the virtual network functions (DHCP, NAT, Firewall, DPI, Load Balancing, etc.).

The network functions manager 450 including the MMI commands of the manager, the commands of the virtual machine manager, or Cloud OS delivers network information of the corresponding virtual machines 411 and QoS information thereof to the flow controller 440 (S501).

Then, the flow controller 440 updates network information of the corresponding virtual machine 411 and QoS information thereof (S502).

The edge agent 413 receives the network information of the virtual machines 411 and the QoS information thereof from the flow controller 440 through the management and control interfaces 490 and 491 (S503), and updates the edge flow switch 412 (S504).

The switch agent 432 receives the updated network information of the virtual machines 411 and the QoS information thereof from the flow controller 440 through the management and control interface 494 (S505), and updates the switch 430 and the flow switch 431 (S506).

The network functions manager 450 delivers the network information of the network function virtual machines 421 and the QoS information thereof to the flow controller 440 (S507).

Then, the flow controller 440 updates the network information of the network function virtual machines 421 and the QoS information thereof (S508).

The network function agent 423 receives the network information and the QoS information, which are updated by the flow controller 440, through the management and control interfaces 492 and 493 (S509), and updates the network function flow switch 422 (S510).

The switch agent 432 receives the network information of the network function virtual machines 421 and the QoS information thereof, which are updated by the flow controller 440, through the management and control interface 494 (S511), and updates the switch 430 (S512).

The server 410 creates the flow according to the service (web server, mail server, file server, video server, cloud server, corporate finance, financing, securities, etc.) that the virtual machines 411 provide (S513), and delivers the flow to the edge flow switch 412 (S514).

The edge flow switch 412 analyzes the flow that is generated by the virtual machines 411 of the server 410, and extracts the flow information thereof (S515).

The edge flow switch 412 checks if the flow generated from the virtual machine 411 is a new one or not through the extracted flow information (S516).

If the flow is the now one, the edge flow switch 412 delivers the extracted new flow information to the edge agent 413 (S517).

The edge agent 413 delivers the new flow information to the flow controller 440 (S518).

The flow controller 440 generates virtual flow information and network function information about the corresponding new flow, and updates the flow tables (the switching table and the network function table) of the flow controller 440 (S519).

The edge agent 413 updates the switching table of the edge flow switch 412 according to the flow tables that are updated by the flow controller 440 (S520 and S521).

The switch agent 432 updates the switching table of the switch 430 according to the flow tables that are updated by the flow controller 440 (S522 and S523).

The network function agent 423 updates the switching table of the edge flow switch 412 according to the flow tables that are updated by the flow controller 440 (S524 and S525).

The edge flow switch 412 processes the flow that is generated from the edge flow switch 412 according to the switching table of the edge flow switch 412 (S526), and delivers the processed flow to the switch 430 through one or more network interfaces 480 and 481 via the L2 switch and/or the L3 switch (S527).

The flow switch 431 of the switch 430 analyzes the flow that is delivered through at least one or more network interfaces 480 and 481 via the L2 switch and/or the L3 switch, and extracts the flow information (S528).

The switch 430 uses the extract flow information to find, in a switching table, a QoS policy of the network information (IP address of the virtual machine, MAC address of the virtual machine, NAT conversion information of the virtual machine, virtual machine bandwidth information, etc.) and QoS information (real-time/non-real-time data, high bandwidth, low bandwidth, delayed sensitive/insensitive, directions of service data (subscriber-server or server-server) etc.) about each virtual machine and QoS information (real-time/non-real-time data, high bandwidth, low bandwidth, delayed sensitive/insensitive, secured/unsecured data service, directions of data (subscriber-server or server-server) etc.) and determines a QoS policy for the received flow based on the network information, the QoS information and the QoS information of the flow.

Then, the flow switch 431 of the switch 430 applies the QoS policy to the corresponding flow that it has been determined (S529).

Next, the switch 430 switches the data flow that is transmitted from the server 410 according to the updated switching table (S530).

If required to execute network functions virtualization for the corresponding data flow, the switch 430 may switch the data flow to the network function server 420 according to the switching table.

If not, the switch 430 may switch the data flow to the other server 410 according to the switching table.

The network function flow switch 422 of the network function server 420 checks a data attribute and a service attribute of the data flow that is delivered from the switch 430 (S531).

Next, the network function flow switch 422 switches the data flow to the network function virtual machine 421 that can execute the virtual network functions according to the switching table of the network function flow switch 422 based on the data and service attributes of the data flow (S532).

Next, the network function virtual machine 421 may apply the virtual network functions to the flow that is received from the network function flow switch 422 (S533).

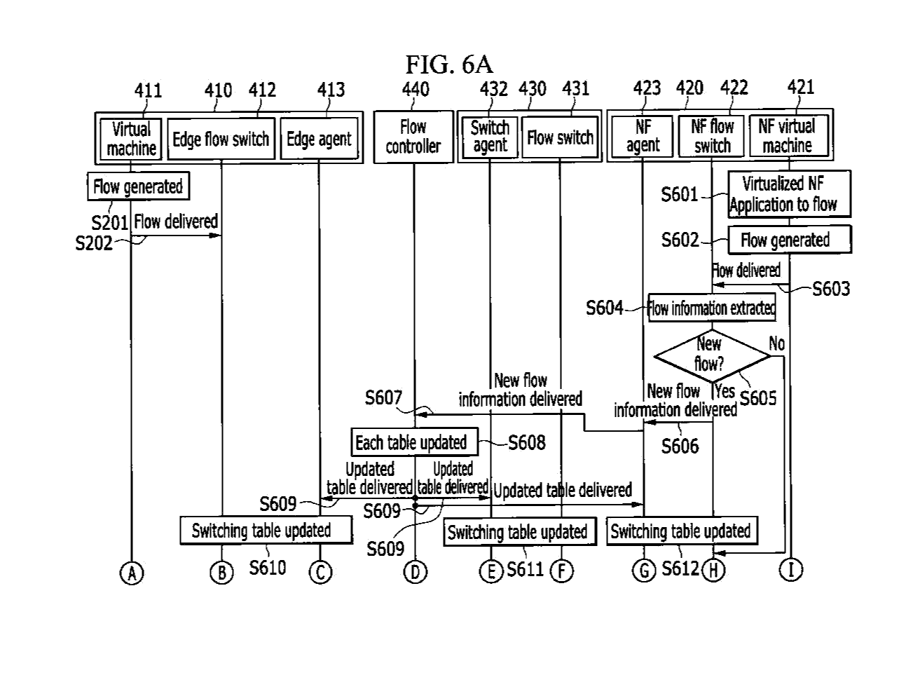

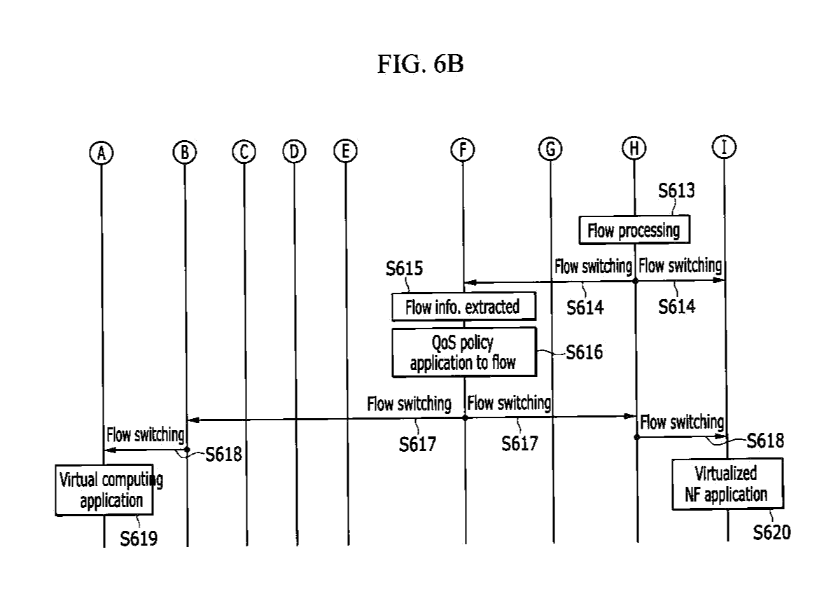

FIGS. 6A and 6B are flowcharts illustrating a processing method of an egress flow according to another exemplary embodiment of the present invention.

Referring to FIGS. 6A and 6B, first, the network function virtual machine 421 applies the virtual network functions to the data flow that is received from the network function flow switch 422 (S601).

Then, the network function virtual machine 421 included in the network function server 420 generates flows according to the virtual network functions (DHCP, NAT, Firewall, DPI, Load Balancing, etc.) that are operated in the network function virtual machines 421 (S602), and delivers the flows to the network function flow switch 422 (S603).

The network function flow switch 422 analyzes the flow that is generated by the network function virtual machine 421 included in the network function server 421, and extracts the flow information (S604).

The network function flow switch 422 checks whether the flow is a new one or not one through the extracted flow information (S605).

If the flow is the new one, the network function flow switch 422 delivers the extracted new flow information to the network function agent 423 (S606).

The network function agent 423 delivers the new flow information to the flow controller 440 (S607), and the flow controller 440 generates virtual flow information and network function information about the corresponding new flow and updates the flow tables (the switching table and the network function table) of the flow controller 440 (S608).

The edge agent 413 updates the switching table of the edge flow switch 412 according to the flow tables that are updated by the low controller 440 (S610).

The switch agent 432 updates the switching table of the switch 430 according to the flow tables that are updated by the flow controller 440 (S611).

The network function agent 423 updates the switching table of the network function flow switch 422 according to the flow tables that are updated by the flow controller 440 (S612).

The network function flow switch 422 processes the flow that is generated by the network function virtual machine 421 included in the network function server 421 according to the switching table of the network function flow switch 422.

Next, the network function flow switch 422 delivers the processed flow through one or more network interfaces 482 and 483 to the switch 430 via the L2 switch and/or the L3 switch (S613 and S614).

The flow switch 431 of the switch 430 analyzes the flow that is delivered through the at least one or more network interfaces 482 and 483, and extracts the flow information thereof (S615).

The switch 430 uses the extracted flow information to find, in a switching table, a QoS policy of the network information (IP address of the virtual machine, MAC address of the virtual machine, NAT conversion information of the virtual machine, virtual machine bandwidth information, etc.) and QoS information (real-time/non-real-time data, high bandwidth, low bandwidth, delayed sensitive/insensitive, directions of service data (subscriber-server or server-server) etc.) about each virtual machine, and QoS information (real-time/non-real-time data, high bandwidth, low bandwidth, delayed sensitive/insensitive, secured/unsecured data service, directions of data (subscriber-server or server-server) etc.) and determines a QoS policy for the received flow based on the network information, the QoS information and the QoS information of the flow.

Then, the flow switch 431 of the switch 430 applies the QoS policy to the corresponding flow that it has been determined (S616).

Next, the switch 430 switches the data flow that is received from the network function server 420 through the network function flow switch 422 according to the switching table (S617).

If required to apply network functions virtualization to the corresponding data flow, the switch 430 may switch the data flow to the network function servers 421 according to the switching table.

If not, the switch 430 may switch the data flow to the other server 410 according to the switching table.

The edge flow switch 412 of the server 410 switches the data flow that is received from the switch 404 to the virtual machines 411 that can execute virtual computing functions according to the switching table of the edge flow switch 412 (S618).

The virtual network function server 420 of the network function flow switch 422 switches the data flow that is received from the switch 430 to the virtual network function virtual machine 421, which can execute the virtual network functions according to the switching table of the network function flow switch 422 (S618).

The virtual machines 411 apply the virtual computing functions to the data flow that is received from the edge flow switch 412 (S619).

The network function virtual machines 421 apply the virtual network functions to the data flow that is received from the network function flow switch 422. As described above, the exemplary embodiment according to the present invention may check the data and service attributes of the received data flow, and may switch the flow to the network function virtual machines according to the data attribute and service attribute thereof, thereby being capable of applying the virtualized network functions in parallel.

Further, QoS may be guaranteed according to the data attribute or service attribute of the flow.

Further, based on the flow information of the flow, the switching table of the network function flow switch may be updated by a burst request, or may be periodically updated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A network function virtualization method capable of applying virtualized network functions to flows, comprising:
receiving the flows;
switching the flows to at least one network function virtual machine according to a switching table of a network function flow switch; and
applying the virtualized network functions to the flows.

2. The method of claim 1, further comprising:
receiving a flow table that is updated based on flow information of a new flow, which is generated from the virtual machine; and
updating the switching table according to the flow table.

3. The method of claim 1, further comprising checking a data attribute or service attribute of the flow after the receiving the flow, wherein the switching of the flow switches the flow to the at least one network function virtual machine according to the switching table based on the data attribute or service attribute.

4. The method of claim 1, wherein the switching of the flow further includes switching the flow according to a service attribute of the at least one network function virtual machine.

5. The method of claim 4, wherein the switching of the flow according to the service attribute of the at least one network function virtual machine includes:
assigning a highest priority to a flow having a service attribute of “server-server” if a service attribute of the at least one network function virtual machine is “server-server”; and
assigning a highest priority to a flow having a service attribute of “subscriber-server” if a service attribute of the at least one network function virtual machine is “subscriber-server”.

6. The method of claim 4, wherein the switching of the flow according to the service attribute of the at least one network function virtual machine includes:
assigning a highest priority to the flow having a service attribute of “real-time QoS” when a service attribute of the at least one network function virtual machine is “real-time service”; and
assigning a highest priority to the flow having a service attribute of “delay sensitive QoS” when a service attribute of the at least one network function virtual machine is “delay sensitive service”.

7. The method of claim 1, wherein the applying of the virtualized network functions includes virtually applying a dynamic host configuration protocol (DHCP) function, a network address translation (NAT) function, a firewall function, a deep packet inspection (DPI) function, or a load balancing function to the flow.

8. The method of claim 1, comprising:
analyzing a first flow that is applied with the virtualized network functions; and
switching the first flow to the virtual machine or the other virtual machine that is different from the virtual machine.

9. The method of claim 8, wherein the analyzing of the first flow includes:
extracting first flow information of the first flow and determining whether the first flow is a new one or not, based on the first flow information;
receiving a flow table that is updated based on the first flow information when the first flow is the new one; and
updating the switching table based on the updated flow table.

10. The method of claim 9, further comprising storing the first flow information in a flow table cache.

11. A network function virtualization device for applying virtualized network functions to flows, comprising:
at least one network function virtual machine configured to apply virtualized network functions to the flow; and
a network function flow switch configured to receive the flow and to switch the flow to the at least one network function virtual machine according to a switching table.

12. The device of claim 11, further comprising a network function agent configured to receive the flow table updated according to the flow information of the new flow, which is generated from the virtual machine, and to update the switching table.

13. The device of claim 11, wherein the network function flow switch is configured to check a data attribute or service attribute of the flow and to switch the flow to the at least one network function virtual machine according to the switching table based on the data attribute or service attribute.

14. The device of claim 11, wherein the network function flow switch is configured to switch the flow according to the service attribute of the at least one network function virtual machine.

15. The device of claim 14, wherein the network function flow switch is configured to assign highest priorities to a flow having a service attribute of “server-server” when a service attribute of the at least one network function virtual machine is “server-server” and to a flow having a service attribute of “subscriber-server” when a service attribute of the at least one network function virtual machine is “subscriber-server”.

16. The device of claim 14, wherein the network function flow switch is configured to assign highest priorities to a flow having a service attribute of “real-time QoS” when a service attribute of the at least one network function virtual machine is “real-time service” and to a flow having a service attribute of “delay-sensitive QoS” when a service attribute of the at least one network function virtual machine is “delay-sensitive service”

17. The device of claim 11, wherein the at least one network function virtual machine is configured to virtually apply a dynamic host predetermined protocol (DHCP) function, a network address translation (NAT), a firewall function, a deep packet inspection (DPI), or a load balancing function to the flow.

18. The device of claim 11, wherein the network function flow switch is configured to analyze a first flow that is applied with the virtualized network function and to switch the first flow to the virtual machine or the other virtual machine that is different from the virtual machine.

19. The device of claim 18, wherein the network function flow switch is configured to extract first flow information of the first flow and to determine whether the first flow is a new one based on the first flow information, and the network function agent is configured to receive the flow table that is updated based on the first flow information when the first flow is the new one and to update the switching table based on the updated flow table.

20. The device of claim 19, wherein the network function flow switch is configured to store the first flow information in a flow table cache.
